(19) United States
(12) Patent Application Publication
(10) Pub. No.: US 2012/0096057 A1
(43) Pub. Date: Apr. 19, 2012

(54) DEFAULT OBJECT FRAGMENTS

(75) Inventor: Scott Cameron, North Vancouver (CA)

(73) Assignee: Business objects Software Ltd., Dublin 1 (IE)

(21) Appl. No.: 12/903,917

(22) Filed: Oct. 13, 2010

(51) Int. Cl. G06F 17/30

(52) U.S. Cl. 707/825; 707/E17.01

(57) ABSTRACT

In a system and a method, a processor-implemented query module identifies a master metadata file. The processor-implemented query module retrieves one or more metadata fragment files having a global identifier matching a global identifier of the master metadata file from a communicatively coupled metadata repository. A processor-implemented generator module combines the master metadata file and the one or more metadata fragment files to form a combined metadata file. The processor-implemented generator module generates a metadata entity from the combined metadata file. The generated metadata entity includes property attributes and property attribute values designated as being owned in each of the master metadata file and the at least one metadata fragment file. A processor-implemented installer module installs the generated metadata entity for consumption by an application.

### TECHNICAL FIELD

This application relates generally to dynamic file generation, and specifically, to a system and method for dynamically generating a metadata file from file fragments.

### BACKGROUND INFORMATION

Metadata is data that provides information about one or more pieces of data (e.g., data, data files, software objects). Depending on the context, metadata may refer to a schema for describing data objects or may be data that describes a specific data object. Metadata also may impart structure or definition to an otherwise loose collection of data. Systems and applications may use metadata to define their functionality and may both consume and produce metadata. In certain instances, the presence of certain metadata may be essential for the application or system to function or function correctly. Proper functioning of the system or application may be threatened if the complete definition of the metadata is not known or ready prior to the installation or use of the application or system.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating an example embodiment of a networked environment within which a client device connects, via a network, with a central management server.

FIG. 2 is an example embodiment of a metadata file stored and managed by the central management server of the example embodiment of FIG. 1.

FIG. 3 is a simplified block diagram of a central management server in accordance with an example embodiment.

FIG. 4 is an example embodiment of a metadata file stored and managed by the central management server of the example embodiment of FIG. 1.

FIG. 5 is a diagram of the interrelationships between metadata fragment files, in accordance with an example embodiment.

FIG. 6 is a flow diagram of an example method for dynamically generating metadata files, in accordance with an example embodiment.

FIG. 7 is a flow diagram of an example method for dynamically generating metadata files, in accordance with an example embodiment.

FIG. 8 illustrates a diagrammatic representation of machine in the example form of a computer system within which a set of instructions, for causing the machine to perform any one or more of the methodologies discussed herein, may be executed.

### DETAILED DESCRIPTION

Various embodiments include at least one of a system, a method, and a tangible computer-readable medium with executable instructions stored thereon providing for the dynamic generation of a metadata entity from fragmented metadata files.

Some such embodiments enable dynamic generation of a metadata entity from a master metadata file and one or more metadata fragment files. A processor-implemented query module may identify a master metadata file and using a global identifier of the master metadata file, may retrieve metadata fragment files having a matching global identifier. A processor-implemented generator module may combine the master metadata file and the metadata fragment files and generate the metadata entity from the master metadata file and the one or more metadata fragment files. The metadata entity may contain property attributes and property attribute values owned by the master metadata file and the one or more metadata fragment files. A processor-implemented installer module may install the generated metadata entity for consumption by an application.

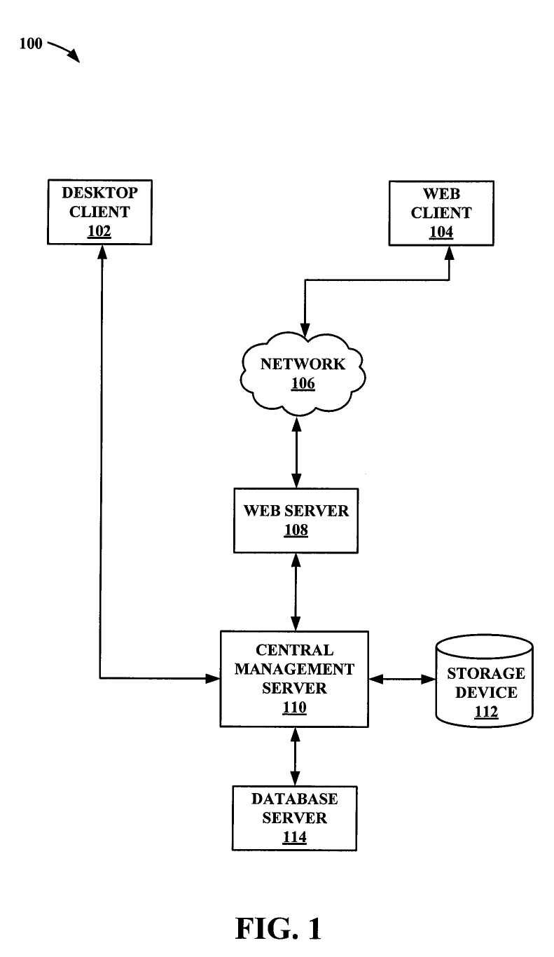

FIG. 1 is a block diagram illustrating an example embodiment of a networked environment 100 within which a client device connects, via a network, with a central management server. Referring to FIG. 1, central management server (CMS) 110 may comprise part of a Business Intelligence (BI) software platform that provides performance management, planning, reporting, query and analysis, and enterprise information management functions. The CMS 110 may store and manage access to metadata used by various applications and components of the BI platform. While the embodiment of FIG. 1 illustrates a CMS 110, it is contemplated that any device capable of storing, retrieving, or interacting or interfacing with metadata may be used in place of the CMS 110. Further, while it has been mentioned that the CMS 110 may be part of a BI platform, it is contemplated that any software platform operating on metadata may be applicable. For example, the networked environment 100 may comprise a business intelligence platform, a business software platform, such as a Customer Relationship Management (CRM) platform or an Enterprise Resource Planning (ERP) platform, or an application platform.

The example embodiment of FIG. 1 further includes a plurality of client devices, including a desktop client 102 and a web client 104. Desktop client 102 may connect to the CMS 110 directly, through a local area network (not shown), or through a wide area network (not shown), such as the Internet. Web client 104 may connect to the CMS 110 by interfacing with web services provided by a web server 108 via a wide area network 106, such as the Internet. Client devices 102, 104 may be a mobile or handheld device, a personal computer (PC), a tablet PC, a terminal device, a Personal Digital Assistant (PDA), or a cellular telephone, among other things. Client devices may interact with applications executing on the BI platform. As part of the interaction, the applications may request access to the CMS 110, retrieve metadata stored in the CMS 110 or one of its associated storage components, or store metadata generated during execution of the application in the CMS 110 or one of its associated storage components.

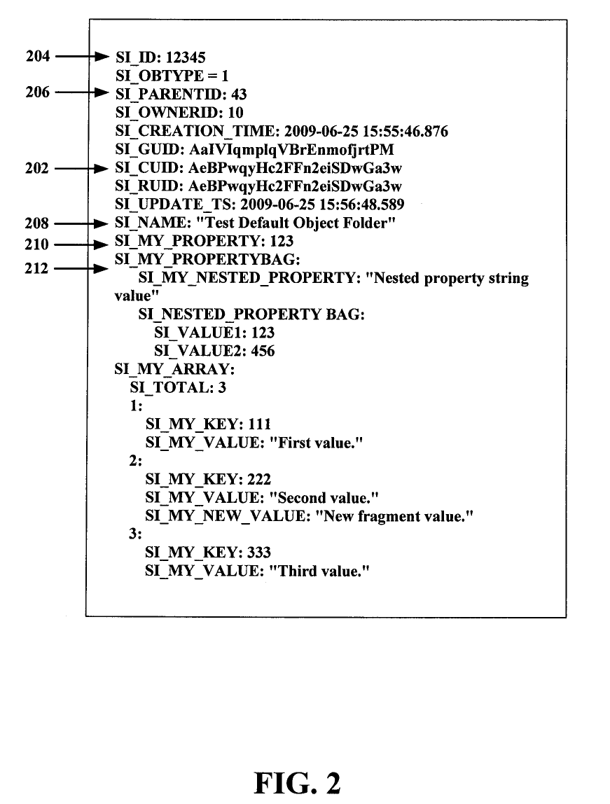

Metadata associated with the system or one of the applications capable of executing on the system may be stored in either or both of an attached storage device 112 that serves as a file system for the CMS 110 and in a database server 114 communicatively coupled to the CMS 110. Collectively, the file system in storage device 112 and the database server 114 may be referred to as a BI platform repository. In an example embodiment, metadata stored in the storage device 112 or the database server 114 may be referred to as Info Objects. An Info Object may be a fundamental unit of consistency in the BI platform. In an example embodiment, all metadata stored in the repository may be stored as Info Objects. An Info Object may comprise a set of properties and property structures that can be recursively nested to an arbitrary level. An example of an Info Object is illustrated in FIG. 2. While a majority of the Info Objects may be created dynamically by system applications, a certain number of Info Objects maintained in the repository may be fundamental Info Objects that are required to be present for the CMS 110 to function properly. For illustrative purposes, the fundamental Info Objects may be designated as Default Objects (DFOs).

The DFOs may be installed as XML files in a file system, such as storage device 112, accessible by the CMS 110. When the CMS 110 starts, it may automatically create Info Objects from the installed DFO files it discovers. The Info Objects based on DFOs may then be consumed by interested applications. In the event an Info Object based on a DFO is deleted from the repository, the CMS 110 will create the Info Object from the DFO again the next time the CMS 110 starts.

In certain circumstances, a complete definition of a DFO may not be known prior to the installation of the components of the BI platform. In addition, a DFO-based Info Object may be consumed by multiple applications owned by different teams that each have their own requirements. As a result, the functionality and performance of the system may be affected.

Example embodiments of the present disclosure address these issues through the dynamic generation of a DFO-based Info Object from distributed fragment files that contain part of the definition of the DFO-based Info Object. The fragments may be independently managed by different owners such that different requirements imposed by the owners may be satisfied through independent ownership of DFO fragments.

Referring to FIG. 2, an example embodiment of a metadata file capable of being stored and managed by the CMS of the example embodiment of FIG. 1 is illustrated. The metadata file may be an Info Object created from a DFO. The Info Object may include, among other things, a global identifier SI_CUID 202, an identifier SI_ID 204, a parent identifier SI_PARENTID 206, and a name SI_NAME 208. The global identifier SI_CUID 202 may be used to link and cross-reference different fragments that are combined to form an Info Object. The Info Object further may include one or more discrete property attributes 210 and a group of property attributes 212, referred to in the example embodiment of FIG. 2 as a “property bag.”

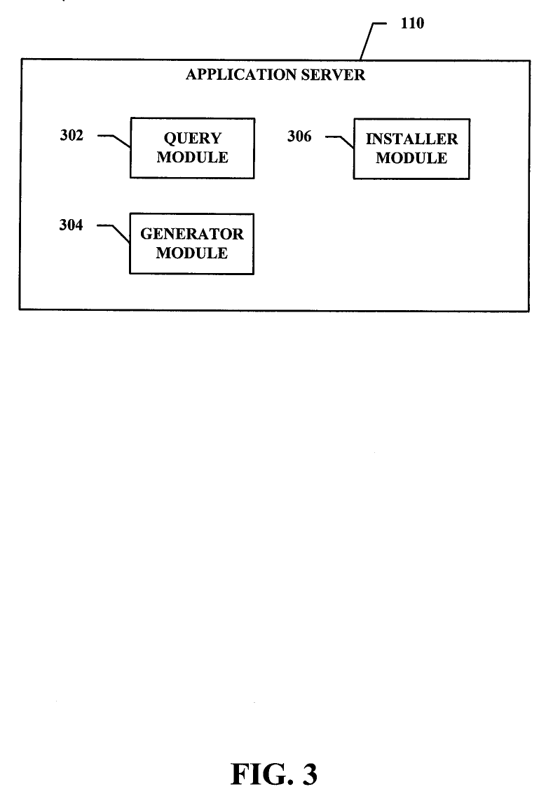

FIG. 3 is a block diagram of a central management server (CMS), in accordance with an example embodiment. The CMS 110 may include a query module 302, a generator module 304, and an installer module 306. Each of the modules illustrated in FIG. 3 may be implemented or executed by one or more processors contained in the CMS 110.

The query module 302 may identify distributed files that may be combined to form a DFO file. In an example embodiment, the distributed files may include a master file and any number of associated fragment files. Using the global identifier SI_CUID discussed above with reference to the example embodiment of FIG. 2, the query module 302 may identify a master file and one or more fragments, each having a global identifier that matches the global identifier of the master file. The master file and the fragment files may be stored locally or remotely, for example, in a file system 112 attached to the CMS 110 or in a database server 114 communicatively coupled to the CMS 110. It is contemplated that other networked or remote storage devices may store master and fragment files capable of being retrieved by the CMS 110. In an example embodiment, the master file may define at least a minimum set of property attributes required for a minimally coherent Info Object. Among these properties may be the global identifier property SI_CUID. Among the properties required by a minimally coherent Info Object, only the global identifier property SI_CUID may need to be defined in a fragment file to allow a fragment to be linked to a master file. Each fragment file may be owned by an independent entity or team such that the fragment file is defined in a way that suits that entity or team's particular requirements or needs. A consequence of the independent ownership of a fragment file is that the entity owning the fragment may define the property attribute and values contained in the fragment.

The generator module 304 may combine the DFO master file and one or more DFO fragment files identified by the query module 302 to form a default object (DFO). As part of the combination process, the generator module 304 may resolve conflicts between property attributes and values contained in the DFO master and fragment files. Additionally, conflicts may be minimized through the design and specification of DFO master and fragment files. Conflicts may be resolved and minimized by having each property in a DFO belong to a single owner file (e.g., a master file or a fragment file). Thus, the master or fragment file designated as the owner of the property is solely responsible for creating, modifying, and deleting the value of the property. The file owning a DFO property is designed to differentiate between properties it “owns” (e.g., payload properties) and properties that are simply used to specify a nesting path.

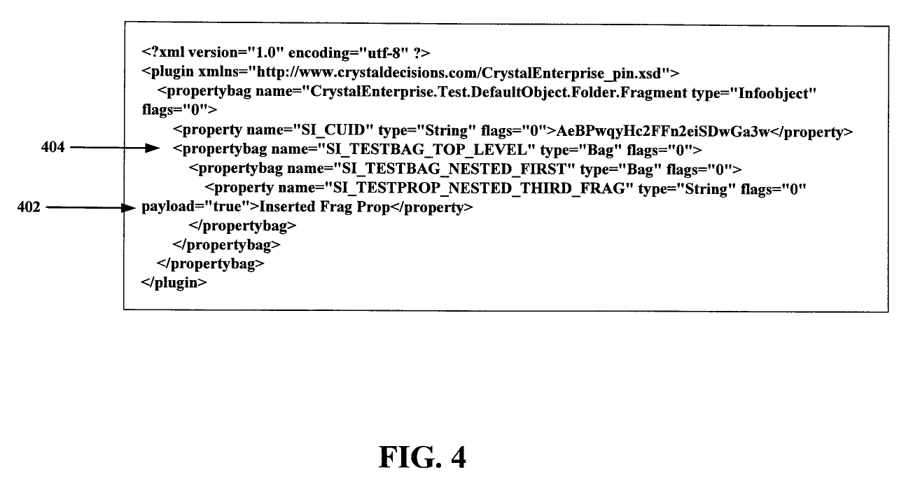

An example of a DFO fragment differentiating between a payload property and a nesting path property is illustrated in FIG. 4. FIG. 4 illustrates that a payload property 402, designated by the “payload=‘true”’ argument, is to be inserted in a payload property 404 having a path “SI_TESTBAG_NESTED_FIRST.” In the example embodiment of FIG. 4, if the payload properties “SI_TEST_BAG_TOP_LEVEL” and “SI_TESTBAG_NESTED_FIRST” do not exist, or if the owned property “SI_TESTPROP_NESTED_THIRD_FRAG” already exists, the DFO fragment may fail to load to avoid generating a conflict between properties of different fragments. Even though the DFO fragment owns one property belonging to the “SI_TESTBAG_NESTED_FIRST” bag, other properties also may exist in the bag. (A bag may be a structure that has assigned to it one or more property attributes.) The loading of the DFO fragment of FIG. 4 may leave the other properties in the bag untouched and may add the payload property 402 to the bag. In addition, a fragment file may be defined in a way that it owns a property bag (i.e., a collection of properties) rather than one property.

Another property structure supported by the fragment may be an array property bag. An array property bag may represent a collection of elements each indexed by an integer value. The elements may be either a discrete property or a property bag containing other properties. When an array property bag is defined in a fragment, one of three actions may occur in a corresponding Info Object generated in part from the fragment. First, the array property bag and all elements defined therein may be inserted into the Info Object. In this sense, the array property bag is the payload being delivered by the fragment. Second, a new element(s) may be inserted into an existing array property bag. The new element(s) is the payload in this scenario. Third, a new property or properties may be inserted into an existing element of an existing array property bag. The property may be the payload in this case.

In an array property bag, different elements may be inserted into the same array from any number of different fragment files. To differentiate between elements in the array, a unique key is specified within each element. The key may be a single property, multiple properties taken together as a composite key, or a property bag (e.g., all properties within the property bag comprising the composite key). In order to mark a property as a key, a “key” attribute may be set to “true” for that property.

Referring back to the example embodiment of FIG. 3, the generator module 304 may assemble the master file and the various fragment files together to form a DFO. In an example embodiment, each fragment file may be combined with the master file sequentially. From the DFO, the generator module 304 may dynamically generate an Info Object. The Info Object may be generated with the property and property values specified in the master file and the various fragment files. If a conflict between properties in the fragment files exists, the generator module 304 may resolve the conflict by applying ownership rules to fragments.

One ownership rule is that only the owner of a property can create, modify, or delete the property. In an example embodiment, in the event two fragments both claim ownership of the same property, the fragment first sequentially encountered may be given ownership of the property. Another ownership rule may be that the lowest-level owner in a nesting hierarchy is considered the owner of the particular nested property. For example, if a fragment called “FragA” inserts a property called “Prop1” and another fragment called “FragB” inserts a nested property called “Prop1.Prop2” (Prop2 being inside of Prop1). Then FragA owns Prop1 but FragB owns Prop1.Prop2. FragA may modify any property inside Prop1 except for Prop2. A third ownership rule may be that a higher-level owner in a nesting hierarchy may modify or delete the higher-level property it owns, and in the process, delete or modify lower-level properties nested within the higher-level property. Using the example described above, if FragA deletes Prop1, then property Prop2 nested inside Prop1 will be deleted as well. Similarly, if FragA decides to update Prop1 with explicit content, then Prop2 may be overwritten since FragA is the owner of Prop1.

Referring back to FIG. 3, with any conflicts between fragment properties resolved, generator module 304 dynamically generates an Info Object from a DFO formed as a combination of the DFO master file and the DFO fragment files. Installer module 306 may receive the generated Info Object from the generator module 304 and may install the generated Info Object in the CMS 110 to allow the BI platform and any applications residing therein to consume the Info Object.

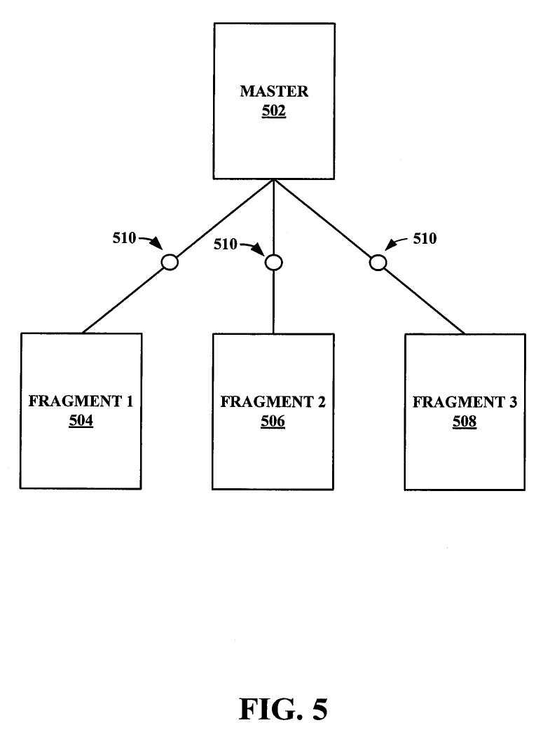

FIG. 5 illustrates a diagram of the interrelationships between metadata fragment files, in accordance with an example embodiment. In the example embodiment of FIG. 5, the metadata fragment files may include a master file 502 and three fragment files 504, 506, 508. Master file 502 may be linked to the three fragment files through a shared global identifier, such as the SI_CUID property attribute, designated by bubbles 510. The query module 302 discussed in connection with the example embodiment of FIG. 3 may first identify a master file 502, and then using the global identifier in the master file 502, identify fragment files 504, 506, 508 having the same global identifier as the master file 502. In an example embodiment, the order in which fragments are loaded for assembly of the DFO may be specified. An order attribute contained within the master file may contain a value. Each fragment also may contain an order value. As fragments are encountered, they may be loaded for generation in order from lowest order value to highest order value. The ordering of fragments may be relevant with respect to property ownership. For example, to avoid conflicts, a fragment that owns a nested property may be loaded before other fragments that define properties within the nested property. In an example embodiment, fragments may be loaded in alphabetical order by file name.

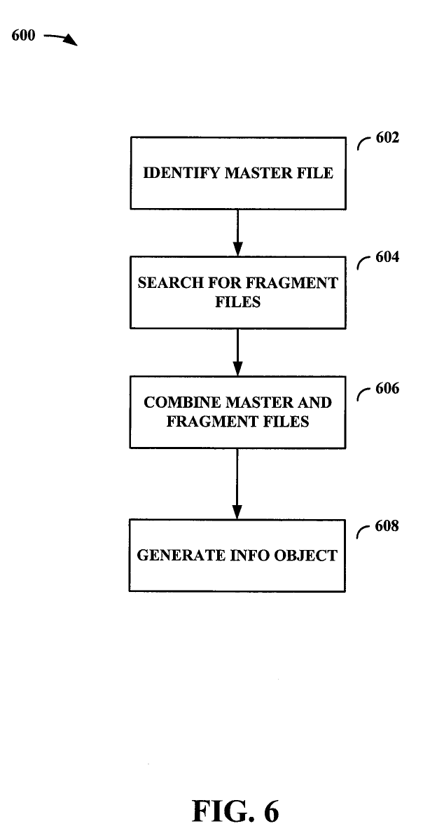

FIG. 6 illustrates a flow diagram of an example method 600 for dynamically generating metadata files, in accordance with an example embodiment. At operation 602, a query module 302 of a central management server 110 may identify a master file 502 to be used to generate an Info Object. Master file 502 may be identified by a global identifier or a different identifier attribute, such as a file identifier or a name, among other things.

At operation 604, the query module 302 may search for fragment files 504, 506, 508 having a global identifier 510 that matches the master file 502. Query module 302 may search both local and remote metadata storage devices, including both a file system attached to the CMS and a database server communicatively connected to the CMS. Query module may search for the master file 502 and the fragment files 504, 506, 508 at the behest of the CMS 110 or an application seeking to consume or retrieve a particular Info Object.

At operation 606, a generator module 304 of the CMS 110 may selectively combine the master file 502 and fragment files 504, 506, 508 to form a default object. Fragments may be dynamically dropped into the file system (e.g., storage device 112) depending on a user's installation choices. For example, if a user chooses to install support for English and French for a particular application, the generator module 304 may select and install the fragment files containing English strings and French strings, but not fragments containing German or Russian strings. As part of operation 606, the generator module 304 may resolve any conflicts between the master file 502 and fragment files 504, 506, 508 or between fragment files themselves. Conflicts may be resolved using ownership rules. The ownership rules may resolve conflicts related to conflicting property attribute values, property ownership, and conflicts related to nested property attribute disputes.

At operation 608, the generator module 304 may generate an Info Object from an assembled default object. An installer module 306 may install the Info Object in the CMS to make the Info Object available for consumption by the BI platform and its applications. In the event the DFO-based Info Object is deleted, the generator module 304 may re-generate the DFO-based Info Object the next time the CMS starts.

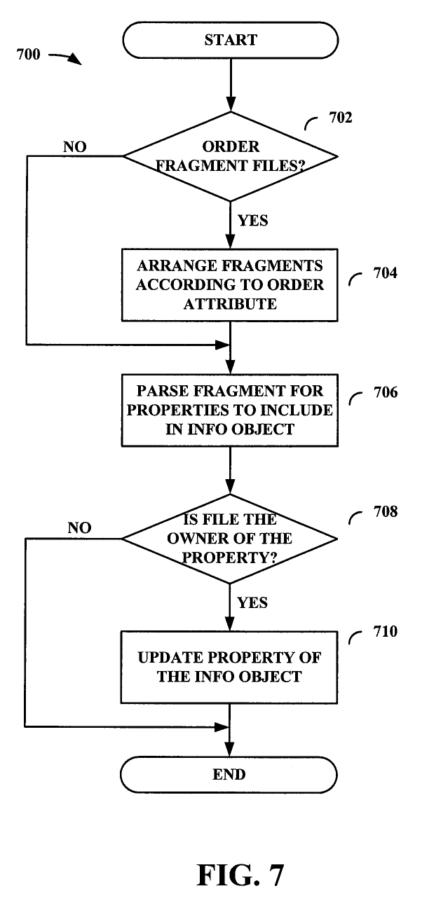

FIG. 7 illustrates a flow diagram of an example method 700 for dynamically generating metadata files, in accordance with an example embodiment. The example method 700 may include additional operations that the CMS 110 may perform when generating an Info Object from a default object. At operation 702, a determination is made as to whether identified fragment files should be assembled or loaded in a particular order when assembling a default object. In an example embodiment, a default option may exist in which fragment files are loaded in alphabetical order. However, if an order attribute in the default object being assembled is present and contains a value, fragments may be loaded by order value. If the determination is made not to order the fragments, the operations may proceed to operation 706.

At operation 704, if the determination is made to order fragment files, fragment files may be loaded in order from lowest order value to highest order value. Each fragment may store an order value in an order attribute. Other order sequences may be employed. For example, fragment files may be loaded in alphabetical order.

At operation 706, each fragment may be parsed to identify the properties contained in the fragment. The one or more properties contained in the fragment may include property attribute values, nested property attribute values, and property array values.

At operation 708, as part of the parsing operation, a determination is made as to whether the fragment is the owner of the property in question. To minimize conflicts among fragment files, properties to be included in the Info Object being generated may be created, modified, or deleted only by the owner of the property. Whether a fragment is an owner of a property may be determined by examining the property attribute for the setting of a flag denoting that the fragment is the owner of the property. In an example embodiment, the flag is called a “payload,” with a fragment being considered a property owner if the “payload” flag is set to “true.”

At operation 710, if the fragment is the owner of the property, the property attribute may be inserted into the Info Object. In the event the property attribute already exists in the Info Object, the value of the property attribute may be overwritten with the value contained in the fragment.

### Modules, Components and Logic

Certain embodiments are described herein as including logic or a number of components, modules, or mechanisms. A component or a module is a non-transitory and tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component or a module may be implemented mechanically or electronically. For example, a component or a module may comprise dedicated circuitry or logic that is permanently configured (e.g., as a special-purpose processor) to perform certain operations. A component or a module also may comprise programmable logic or circuitry (e.g., as encompassed within a general-purpose processor or other programmable processor) that is temporarily configured by software to perform certain operations. It will be appreciated that the decision to implement a component or a module mechanically, in dedicated and permanently configured circuitry, or in temporarily configured circuitry (e.g., configured by software) may be driven by cost and time considerations.

Accordingly, the term “component” or “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components or modules are temporarily configured (e.g., programmed), each of the components or modules need not be configured or instantiated at any one instance in time. For example, where the components or modules comprise a general-purpose processor configured using software, the general-purpose processor may be configured as respective different components or modules at different times. Software may accordingly configure a processor, for example, to constitute a particular component or module at one instance of time and to constitute a different component or module at a different instance of time.

Components or modules can provide information to, and receive information from, other components or modules. Accordingly, the described components or modules may be regarded as being communicatively coupled. Where multiple of such components or modules exist contemporaneously, communications may be achieved through signal transmission (e.g., over appropriate circuits and buses) that connect the components or modules. In embodiments in which multiple components or modules are configured or instantiated at different times, communications between such components or modules may be achieved, for example, through the storage and retrieval of information in memory structures to which the multiple components or modules have access. For example, one component or module may perform an operation, and store the output of that operation in a memory device to which it is communicatively coupled. A further component or module may then, at a later time, access the memory device to retrieve and process the stored output. Components or module may also initiate communications with input or output devices, and can operate on a resource (e.g., a collection of information).

### Example Machine Architecture and Machine-Readable Medium

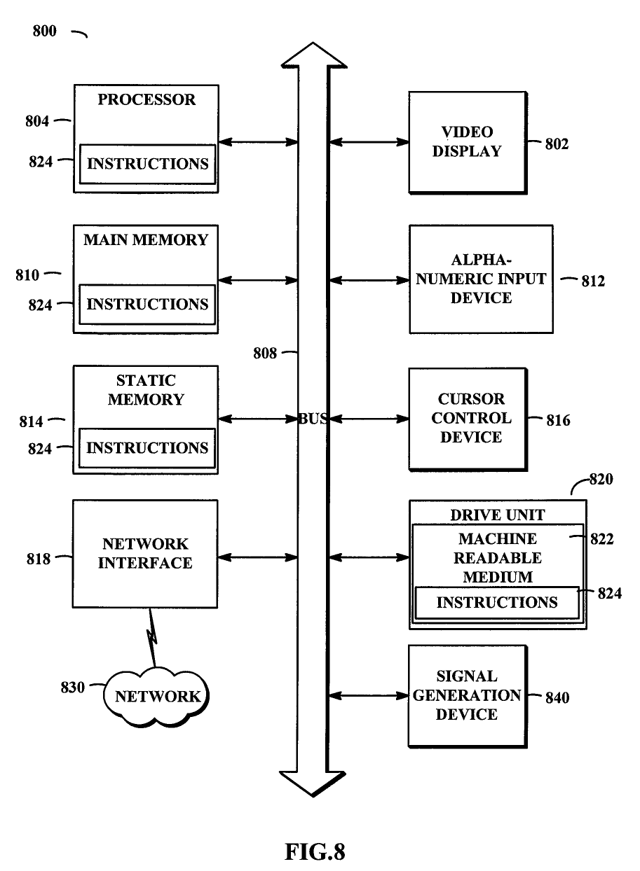

FIG. 8 illustrates a diagrammatic representation of machine in the example form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client device or machine 102, 104, 106 of FIG. 1 in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes at least one processor 804 (e.g., a central processing unit (CPU), a graphics processing unit (GPU) or both), a main memory 8010 and a static memory 814, which communicate with each other via a bus 808. The computer system 800 may further include a video display unit 802 (e.g., a liquid crystal display (LCD) or a cathode ray tube (CRT)). The computer system 800 also includes an alphanumeric input device 812 (e.g., a keyboard), a user interface (UI) navigation device 816 (e.g., a mouse), a disk drive unit 820, a signal generation device 840 (e.g., a speaker) and a network interface device 818.

The disk drive unit 820 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 810 and/or within the processor 804 during execution thereof by the computer system 800, the main memory 810 and the processor 804 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 824 may further be transmitted or received over a communications network 830 using a transmission medium. The software 824 may be transmitted using the network interface device 818 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible medium to facilitate communication of such software.

### Example Three-Tier Software Architecture

In some embodiments, the described methods may be implemented using one of a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules, or processes that govern the software as a whole. A third, storage tier, may be a persistent storage medium, or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology, or, a variety of technologies. The example three-tier architecture, and the technologies through which it is implemented, may be realized on one or more computer systems operating, for example, as a standalone system, or organized in a server-client, peer-to-peer, distributed or so some other suitable configuration. Further, these three tiers may be distributed between more than one computer systems as various components.

### Components

Example embodiments may include the above-described tiers, and processes or operations about constituting these tiers may be implemented as components. Common to many of these components is the ability to generate, use, and manipulate data. The components, and the functionality associated with each, may form part of standalone, client, server, or peer computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above-described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, peer-to-peer, or some other suitable configuration. Software for the components may be written using the above-described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Example embodiments may use the OSI model or TCP/IP protocol stack model for defining the protocols used by a network to transmit data. In applying these models, a system of data transmission between a server and client, or between peer computer systems may for example include five layers comprising: an application layer, a transport layer, a network layer, a data link layer, and a physical layer. In the case of software, for instantiating or configuring components, having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A system, comprising:
a processor-implemented query module configured to:
identify a master metadata file; and
retrieve at least one metadata fragment file from a communicatively connected metadata repository, the at least one metadata fragment file having a global identifier matching a global identifier of the master metadata file;
a processor-implemented generator module configured to:
combine the master metadata file and the at least one metadata fragment file to form a combined metadata file, the combining the master metadata file and the at least one metadata fragment file including resolving conflicting property attributes among the master metadata file and the at least one metadata fragment file using an ownership rule;
generate a metadata entity from the combined metadata file, the metadata entity including property attributes and property attribute values designated as being owned in each of the master metadata file and the at least one metadata fragment file; and
a processor-implemented installer module configured to install the generated metadata entity for consumption by at least one application.

2. The system of claim 1, wherein the property attributes include at least one of a discrete property attribute, a group of property attributes, and an indexed collection of property attributes.

3. The system of claim 1, wherein the processor-implemented generator module is configured to combine the master metadata file and the at least one metadata fragment file in a predetermined order.

4. The system of claim 3, wherein each of the master metadata file and the at least one metadata fragment file includes an order value, and wherein the predetermined order arranges the master metadata file and the at least one metadata fragment file by a lowest order value to a highest order value.

5. The system of claim 1, wherein ownership of a property attribute by one of the master metadata file and the at least one metadata fragment file is determined by a setting of an ownership flag in the one of the master metadata file and the at least one metadata fragment file.

6. The system of claim 1, wherein an owner of a property attribute exclusively possesses a right to create, modify, and delete the property attribute.

7. The system of claim 2, wherein the group of property attributes is a structure containing a nested set of property attributes, wherein an owner of a lower level nested property attribute of the nested set of property attributes possesses a right to create, modify, and delete only the lower level property attribute, and wherein an owner of the structure containing the nested set of property attributes possesses a right to create, modify, and delete the structure of the nested set of property attributes and unowned nested property attributes in the nested set of property attributes.

8. The system of claim 2, wherein the indexed collection of property attributes is indexed according to a key, the key comprising at least one of a property attribute in the indexed collection of property attributes, a plurality of property attributes in the indexed collection of property attributes, and a set of nested property attributes in the indexed collection of property attributes.

9. The system of claim 1, wherein the master metadata file and the at least one metadata fragment file are Extensible Markup Language (XML) files.

10. A computer-implemented method, comprising:
identifying a master metadata file;
retrieving, by a metadata management server, at least one metadata fragment file from a metadata repository communicatively connected to the metadata management server, the at least one metadata fragment file having a global identifier matching a global identifier of the master metadata file;
combining the master metadata file and the at least one metadata fragment file to form a combined metadata file, the combining the master metadata file and the at least one metadata fragment file including resolving conflicting property attributes among the master metadata file and the at least one metadata fragment file using an ownership rule;
generating a metadata entity from the combined metadata file, the metadata entity including property attributes and property attribute values designated as being owned in each of the master metadata file and the at least one metadata fragment file; and
installing, in the metadata management server, the generated metadata entity for consumption by at least one application having access to the metadata management server.

11. The computer-implemented method of claim 10, wherein the property attributes include at least one of a discrete property attribute, a group of property attributes, and an indexed collection of property attributes.

12. The computer-implemented method of claim 10, wherein the combining the master metadata file and the at least one metadata fragment file comprises combining the master metadata file and the at least one metadata fragment file in a predetermined order.

13. The computer-implemented method of claim 12, wherein each of the master metadata file and the at least one metadata fragment file includes an order value, and wherein the predetermined order arranges the master metadata file and the at least one metadata fragment file by a lowest order value to a highest order value.

14. The computer-implemented method of claim 10, wherein ownership of a property attribute by one of the master metadata file and the at least one metadata fragment file is determined by a setting of an ownership flag in the one of the master metadata file and the at least one metadata fragment file.

15. The computer-implemented method of claim 10, wherein an owner of a property attribute exclusively possesses a right to create, modify, and delete the property attribute.

16. The computer-implemented method of claim 11, wherein the group of property attributes is a structure containing a nested set of property attributes, wherein an owner of a lower level nested property attribute of the nested set of property attributes possesses a right to create, modify, and delete only the lower level property attribute, and wherein an owner of the structure containing the nested set of property attributes possesses a right to create, modify, and delete the structure of the nested set of property attributes and unowned nested property attributes.

17. The computer-implemented method of claim 11, wherein the indexed collection of property attributes is indexed according to a key, the key comprising at least one of a property attribute in the indexed collection of property attributes, a plurality of property attributes in the indexed collection of property attributes, and a set of nested property attributes in the indexed collection of property attributes in the nested set of property attributes.

18. The computer-implemented method of claim 10, wherein the master metadata file and the at least one metadata fragment file are Extensible Markup Language (XML) files.

19. A non-transitory machine-readable storage medium storing a set of instructions that, when executed by a processor, causes the processor to perform operations, comprising:
identifying a master metadata file;
retrieving, by a metadata management server, at least one metadata fragment file from a metadata repository communicatively connected to the metadata management server, the at least one metadata fragment file having a global identifier matching a global identifier of the master metadata file;
combining the master metadata file and the at least one metadata fragment file to form a combined metadata file, the combining the master metadata file and the at least one metadata fragment file including resolving conflicting property attributes among the master metadata file and the at least one metadata fragment file using an ownership rule;
generating a metadata entity from the combined metadata file, the metadata entity including property attributes and property attribute values designated as being owned in each of the master metadata file and the at least one metadata fragment file; and
installing, in the metadata management server, the generated metadata entity for consumption by at least one application having access to the metadata management server.

20. The non-transitory machine-readable storage medium of claim 19, wherein the property attributes include at least one of a discrete property attribute, a group of property attributes, and an indexed collection of property attributes.

21. The non-transitory machine-readable storage medium of claim 19, wherein the combining the master metadata file and the at least one metadata fragment file comprises combining the metadata entity from the master metadata file and the at least one metadata fragment file in a predetermined order.

22. The non-transitory machine-readable storage medium of claim 21, wherein each of the master metadata file and the at least one metadata fragment file includes an order value, and wherein the predetermined order arranges the master metadata file and the at least one metadata fragment file by a lowest order value to a highest order value.

23. The non-transitory machine-readable storage medium of claim 19, wherein ownership of a property attribute by one of the master metadata file and the at least one metadata fragment file is determined by a setting of an ownership flag in the one of the master metadata file and the at least one metadata fragment file.

24. The non-transitory machine-readable storage medium of claim 19, wherein an owner of a property attribute exclusively possesses a right to create, modify, and delete the property attribute.

25. The non-transitory machine-readable storage medium of claim 20, wherein the group of property attributes is a structure containing a nested set of property attributes, wherein an owner of a lower level nested property attribute of the nested set of property attributes possesses a right to create, modify, and delete only the lower level property attribute, and wherein an owner of the structure containing the nested set of property attributes possesses a right to create, modify, and delete the structure of the nested set of property attributes and unowned nested property attributes in the nested set of property attributes.

26. The non-transitory machine-readable storage medium of claim 20, wherein the indexed collection of property attributes is indexed according to a key, the key comprising at least one of a property attribute in the indexed collection of property attributes, a plurality of property attributes in the indexed collection of property attributes, and a set of nested property attributes in the indexed collection of property attributes.

27. The non-transitory machine-readable storage medium of claim 19, wherein the master metadata file and the at least one metadata fragment file are Extensible Markup Language (XML) files.
